(19) United States
(12) Patent Application Publication
(10) Pub. No.: US 2010/0083464 A1
(43) Pub. Date: Apr. 8, 2010

(54) Parallel Axes Compound Balance

(75) Inventors: Robert Lucci, Rochester, NY (US); Wilbur James Kellum, III, Hilton, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 12/568,288

(22) Filed: Sep. 28, 2009

Related U.S. Application Data
(60) Provisional application No. 61/102,096, filed on Oct. 2, 2008.

(51) Int. Cl. E05F 7/00

(52) U.S. Cl. 16/197

(57) ABSTRACT

An apparatus and method to substantially cancel out the opposing torsional forces of the torsion spring of a spiral rod subassembly and the extension spring of a compound spiral rod balance on the carrier element. The extension spring and the rod spiral balance subassembly are parallel, connected at their lower ends to a carrier element and at their top ends either to an upper mounting cap or separately to the wall of the jamb channel. The spiral rod is turned a pre-determined number of times in a direction opposite from that in which the extension spring is turned so that the torsional forces acting on the carrier element from the torsion spring and the extension spring substantially cancel out each other. The balancing out of the counteracting torsional forces eliminates or substantially reduces the friction between the carrier element and the jamb channel.

### REFERENCE TO RELATED APPLICATIONS

This application claims one or more inventions which were disclosed in Provisional Application No. 61/102,096, filed Oct. 2, 2008, entitled “Parallel Axes Low Torque Compound Balance”. The benefit under 35 USC §119(e) of the United States provisional application is hereby claimed, and the aforementioned application is hereby incorporated herein by reference.

### FIELD OF THE INVENTION

The invention pertains to the field of window balances, specifically compound balances that traditionally exhibit torsional forces. More particularly, the invention pertains to a means for connecting the springs used in a compound balance. The connecting means substantially equalizes the opposing torsional forces of the spiral and extension springs acting on the carrier of the compound balance.

### BACKGROUND OF THE INVENTION

Vertically sliding window assemblies may consist of either a single sash or two sashes, and are referred to, respectively, as single hung or double hung windows. A hung window assembly generally includes a window frame, at least one sash, a pair of opposing window jambs, each jamb having a channel for allowing the vertical travel of each sash, and at least one window balance to assist with the raising and lowering of the sash to which it is attached by providing a force to counterbalance the weight of the sash.

Springs are utilized to provide the counterbalancing force and are especially useful for operating very heavy sashes. Compound balances are preferred for facilitating the operation of these very heavy sashes. In compound balances, a torsion spring provides a lifting force over the full travel of the sash through the jamb channel. The torsion spring force is converted into a lifting force by extending an elongated spiral rod. The torsion spring and elongated spiral rod comprise the balance sub-assembly and are surrounded by an extension spring. Alternative designs will have the sub-assembly encapsulated within a containment tube. It is desirable that the combined axial forces of the torsion spring and extension spring provide substantially constant lifting force over the full vertical travel of the compound balance. The compound balance has an open end, from which the spiral rod extends, and a closed end, which is securely fastened to the wall of the jamb channel of the window frame.

The open end of the compound balance is capped by a rotatable coupling having a central opening through which the elongated spiral rod travels. When the telescoping end of the spiral rod is attached to a window sash, depending on the direction of vertical movement required to open the window, the spiral rod is either substantially fully extended or substantially fully retracted into the balance. In a double hung window design the upper sash moves in a downward direction to open that portion of the window while the lower sash moves upwardly to open that respective portion of the window.

In tilting window sashes, the extended end of the spiral rod connects to a shoe or carrier which traverses up and down the jamb channel of the window assembly with the sash. The window sash and window balance are linked together through the shoe/carrier by means of a pivot bar which extends from the end of the stile of the sash into the carrier.

Alternatively, the end of the spiral rod may attach directly to the sash itself. In this case, a clip is securely attached to the end of the spiral rod. The conventional means of attaching the clip to the spiral rod consists of the use of a rivet or by means of an interference fit clip.

Especially with respect to windows having large, very heavy sashes, it is highly desirable to design a balance that provides the most lifting assistance. In order to accomplish this objective, the torsional forces of the torsion spring should be as low as possible. If the spring exhibits too much torsional force, then the window operator must overcome not only the unbalanced weight of the sash but also the surplus frictional force acting on the carrier in the jamb channel due to the other spring. It is very desirable therefore to limit or entirely eliminate the amount of torque transferred from the compound balance to the connecting hardware. A reduction in the transfer of this torque will facilitate the raising or lowering the sash.

### SUMMARY OF THE INVENTION

The present invention is an apparatus and method that substantially cancels out the torsional forces exerted on the carrier element by the torsion spring so that the force on the carrier element of a compound balance is substantially in a state of equilibrium and exhibits either no or minimal torque which would create frictional forces that would increase the amount of energy needed to raise or lower the window sash. The carrier element can be either a conventional carrier or simply a rectangular block sized to fit in the jamb channel. In the compound balance of the invention, the spiral rod sub-assembly, which consists of the spiral rod and the torsion spring (and, optionally, a containment tube may surround the torsion spring), is aligned along side with and parallel to the extension spring. The first ends of each the spiral rod assembly and the extension spring are secured to the carrier element. The block could be the carrier for either tilt or non-tilt sashes. The top, or second, ends of both the extension spring and the spiral rod sub-assembly are secured to the wall of the jamb channel by a pin, rivet, eyelet, screw or similar such means. Alternatively, an upper block may secure the top ends of both the spiral rod sub-assembly and the extension spring. At this location, both the torsion spring and the extension spring are securely fixed into place relative to the window frame assembly. During assembly of the balance, the spiral rod is rotated to create a pre-determined force on the torsion spring. The entire sub-assembly is then retracted into the balance to be seated against a pre-tension torque seat. The first (or open) end of the spiral rod is securely seated within the block. In this manner, the pre-tension that has been applied to the spiral rod is maintained.

The free end of the extension spring, which is parallel to the spiral rod sub-assembly, is aligned for insertion through a hole adjacent the point of attachment of the spiral rod in the carrier element. The extension spring is wound such that the torque opposes the torque exhibited by the torsion spring. An attachment means is secured to the end of the extension spring that extends through the hole in the block. For purposes of description hereinafter the attachment means is known as an assembly connector. The assembly connector consists of variations that allow for the placement of turns on the extension spring. This may be achieved by integrally forming an extender to the end of the assembly connector and then attaching at least one pin thereto. The assembly connector is turned a pre-determined number of times and then seated within the carrier element so that it provides a torque that is opposite to the torque applied to the torsion spring. Consequently, less friction is generated between the carrier element and the jamb channel thereby requiring less force to raise or lower the sash. The seating of the assembly connector and the spiral rod in the carrier element maintains substantial equilibrium between the torsional force of the torsion spring and the torsional force of the extension spring.

### BRIEF DESCRIPTION OF THE DRAWING

FIG. 1 shows a compound balance with the spiral rod sub-assembly and the extension spring arranged in parallel attached to a carrier element.

FIG. 2 shows a compound balance as a cartridge where the spiral rod sub-assembly and the extension spring are secured at their top ends by an upper block and at their lower ends by a carrier element.

FIG. 3 shows a first embodiment of the assembly connector aligned with the hole in the carrier element through which the extension spring is to be inserted.

FIG. 4 shows the embodiment of FIG. 3 from a different visual perspective.

FIG. 5 shows a second embodiment of the assembly connector, aligned for insertion into the extension spring hole in the carrier element.

### DETAILED DESCRIPTION OF THE INVENTION

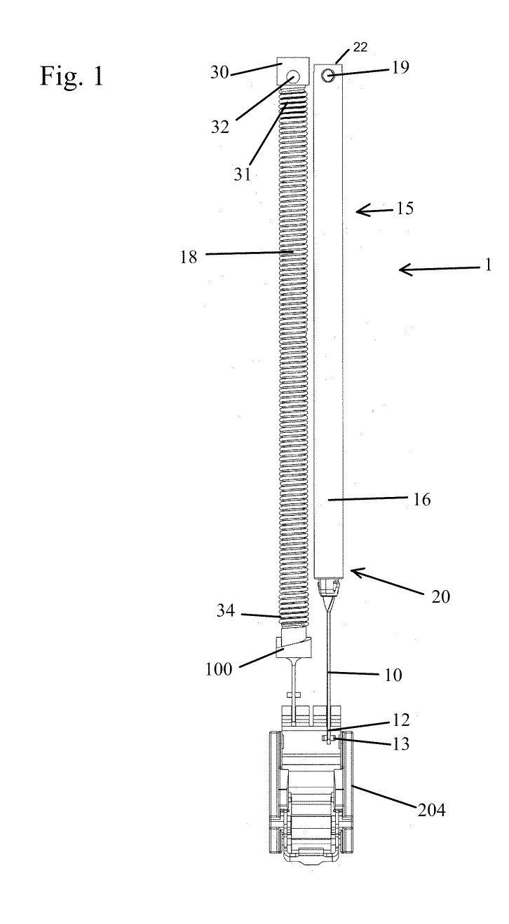

As shown in FIG. 1, conventional compound window (or sash) balances consist of at least a spiral rod 10 having a first end 12 that extends from a first end 20 of the compound balance 1. The spiral rod 10 is secured to a conventional spiral shaped torsion spring (not shown) within the compound balance 1. The combination of the spiral rod 10 and the torsion spring are commonly referred to as the “spiral rod sub-assembly” 15. The torsion spring may be either encapsulated, as shown in FIG. 1, by an optional containment tube 16 or it may remain non-encapsulated. FIG. 1 shows the sub-assembly encapsulated by a containment tube 16. Nonetheless, whether a containment tube 16 is present or not (and when present, is considered part of the spiral rod sub-assembly 15), an extension spring 18 runs parallel to the containment tube 16. The direction of the turns (or rotations) applied to the torsion spring and the extension spring 18 are opposite to each other in order to provide the balance manufacturer with the ability to cancel out these opposing torsional forces acting on the carrier element 204. The more equal are these opposing forces, the less friction exists between the carrier element 204 and the jamb channel thereby creating more assistance to the operator moving the sash either up or down.

The first end 12 of the spiral rod 10 extends out of the first end 20 of the containment tube 16. In a first embodiment, the second end 22 of the spiral rod sub-assembly 15 is firmly secured to a wall of the jamb channel (not shown) by use of a screw, rivet, eyelet, etc. (not shown) through hole 19. By securing the spiral rod sub-assembly 15 at its second end 22 to the wall of the jamb channel, a torsional force can be applied to the torsion spring (not visible within the containment tube 16) of the spiral rod sub-assembly. Although the torsional force is intended to provide a progressive force that urges the spiral rod to retract into the spiral rod sub-assembly 15 to assist the operator with the vertical movement of the sash, this creates a torsional force that generates substantial friction between the carrier element 204 and the walls of the jamb channel. This friction impedes easy operation of the sash.

An assembly connector 100, shown in FIGS. 1-5 is then connected to the lower end 34 of the extension spring 18. Then, the extension spring 18 may be wound in a direction opposite from the direction of the turns applied to the torsion spring. The assembly connector substantially alleviates the undesired transfer of the torsionally induced friction from the torsion spring to other components of the window assembly.

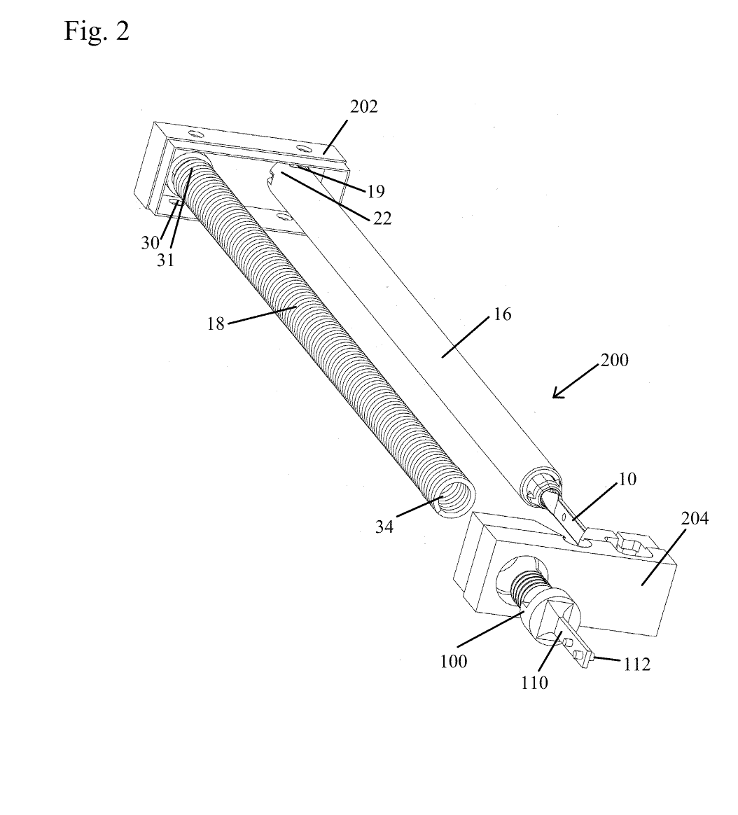

In a second embodiment of the compound balance 1, a cartridge assembly 200 is best shown in FIG. 2. It consists of an upper mounting cap 202 and a lower carrier element, in this instance shown as a block shaped element, 204′. Both the upper mounting cap 202 and the block element 204′ are designed to fit within the jamb channel of a window assembly and slide therethrough with minimal resistance. The top end 31 of the extension spring 18 is “wound” or turned into the upper mounting cap 202. The mounting cap 202 is then secured to the wall of the jamb channel by use of a conventional eyelet, screw, rivet, etc. (not shown) through at least one hole 30.

With the extension spring wound securely onto the upper mounting cap 202, the lower end 34 of the extension spring 18 may be loosely inserted through hole 206 in the block element 204′. The assembly connector 100 is then securely screwed into the lower end 34 of extension spring 18.

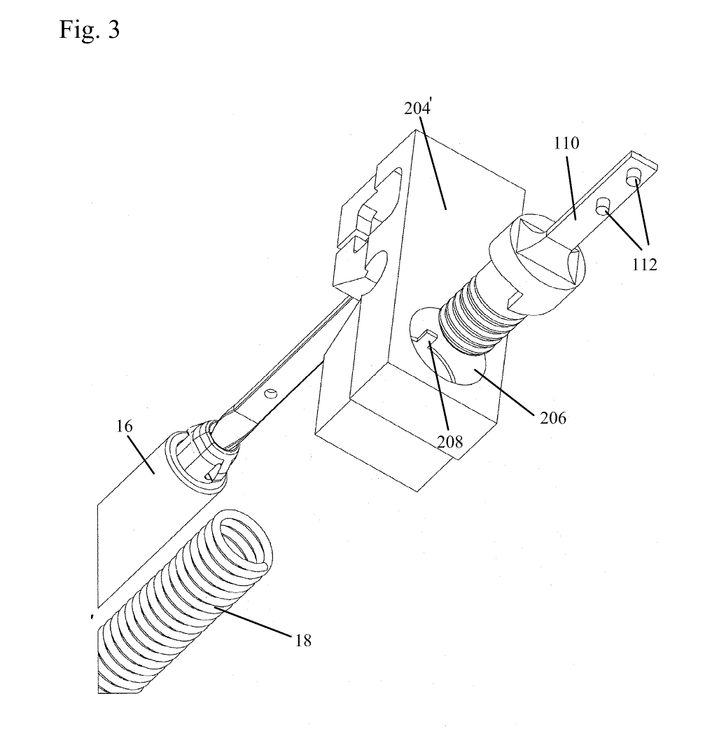

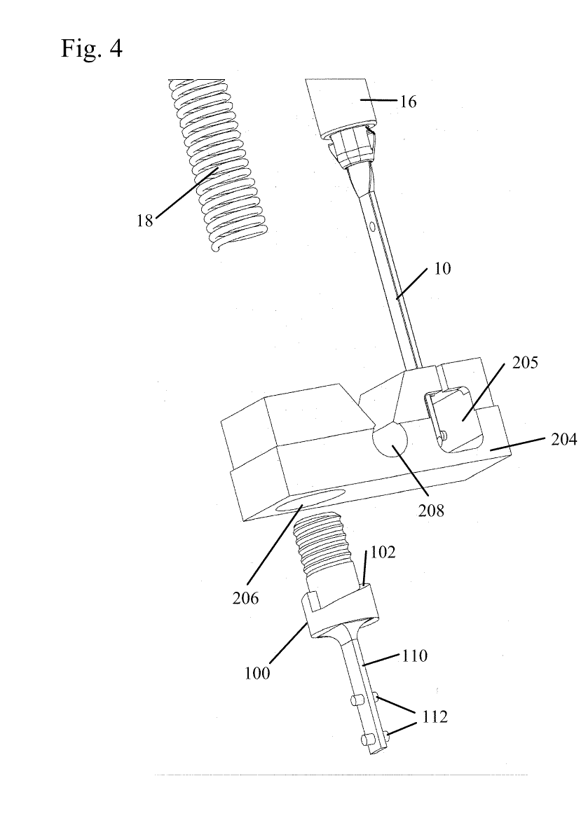

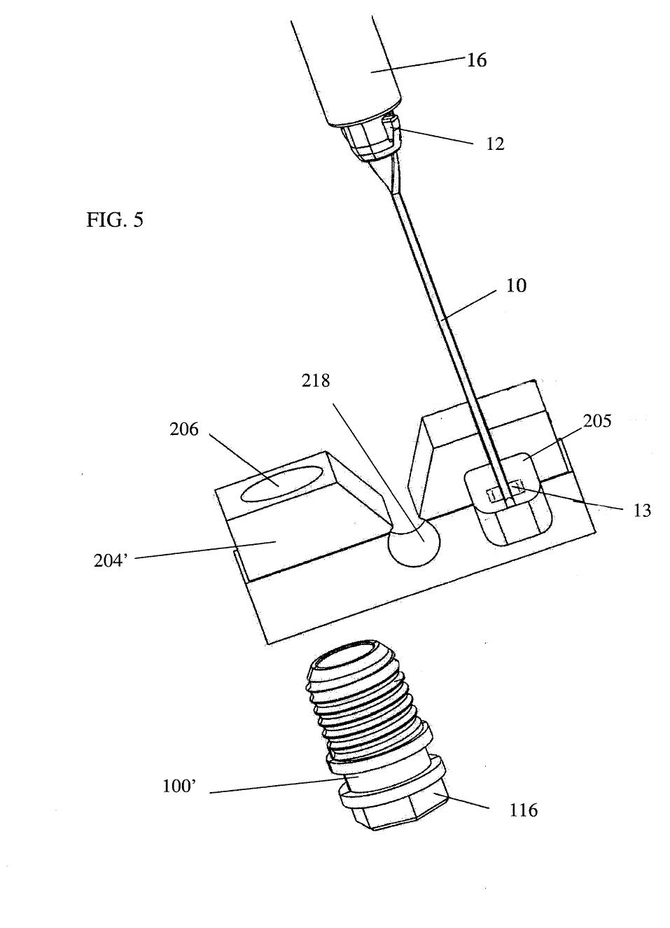

As best shown in FIG. 4, assembly connector 100 contains an annular ramp 102 which is engagable with at least one tab 208 (FIG. 3) within hole 206. As best shown in FIG. 5, once the turns, or torque, have been applied to spiral rod 10, it is seated securely within an interior opening 205 on one side of the block element 204′. A pin or rivet 13 secures spiral rod 10 to the block element 204′.

In the method of assembling either embodiment of the present invention, the spiral rod 10 is turned, which creates a torsional force on the torsion spring of the spiral rod sub-assembly 15. The spiral rod 10 is then allowed to retract into the compound balance 1 without further rotation and is seated into an internal anchor (not shown) located within the second end 22 of the spiral rod spiral rod sub-assembly 15. The anchor maintains the torsional force applied to the torsion spring.

Next, a counter torque is applied to the extension spring 18 by turning it in a direction opposite from the direction of the turns that had been applied to the spiral rod 10 of the spiral rod sub-assembly 15. The assembly connector 100 is attached to the lower end 34 of the extension spring 18. In another variation, the turns may be applied with the assembly connector 100 already attached to the extension spring 18. The preferred method is to spin the assembly connector 100 onto the threads of the extension spring 18. Once a pre-determined amount of turns have been applied to the extension spring 18, the assembly connector 100 is inserted into hole 206 of the block element 204′, until the end portion (not shown) of each ramp 102 seats against one of the tabs 108. The amount of torque applied to the extension spring 18 should equal out the amount of torque applied to the torsion spring of the spiral rod sub-assembly 15.

The balance manufacturer may produce and ship both embodiments of the parallel compound balance 1, the first embodiment having the top ends of the extension spring and the containment tubes “float” freely until each is secured to a wall of the jamb channel, the second embodiment using an upper mounting cap 202 (FIG. 2) thereby creating an assembly whereby both the extension spring 18 and the spiral rod sub-assembly 15 are secured to both the upper mounting cap 202 and the carrier element 204.

Once either embodiment is shipped to the window manufacturer, instructions can be provided to “set the torque” of the extension spring by applying a predetermined number of turns to the assembly connector 100. In one variation of the assembly connector shown in FIG. 4, an extender 110 is integrally formed with the main body of the assembly connector 100. At least one pin or eyelet 112, is secured to the extender 110. A hook or some similar tool may be operably engaged with pin 112 in order to pull the assembly connector 100 from its seat within the carrier element 204, additional turns may be applied to it to counterbalance the torsional force produced by the spiral rod sub-assembly 15. Once the predetermined number of turns has been applied to the extension spring 18, the assembly connector 100 is reinserted back into hole 206 and allowed to re-seat itself to maintain the torsional force which has been applied to the extension spring.

A variation of the assembly connector 100 of FIG. 4 is the assembly connector 100′ of FIG. 5. In this variation, additional turns are applied to the extension spring 18 (not shown in this Figure) by using tools, such as channel locks or wrenches, to operably engage adjustment engagement feature 116 to turn assembly connector 100.

The carrier element 204 or, as shown in FIG. 5, the block element 204′, may be configured to contain a notch 218 for receiving a pivot bar with a cam assembly. Some non-limiting examples of such carriers may be found in U. S. Patent Pub. No. 2007/0101652 and U.S Patent Pub. No. 2007/0101654. This design would effectively make the mounting block 204′ a pivotable sash carrier. Either carrier element 204 or block element 204′ may be used interchangeably with either the first or the second embodiment of the assembly connector 100.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A compound balance comprising:
a) an extension spring having a first end and a second end;
b) a spiral rod subassembly consisting of a spiral rod encased within a torsion spring, the spiral rod subassembly having a first end and a second end; and
c) a carrier element sized to fit and substantially freely travel within a jamb channel of a window assembly;
wherein the first end of the extension spring and the first end of the spiral rod subassembly are engaged with the carrier element.

2. The compound balance of claim 1 further comprising a containment tube surrounding the torsion spring.

3. The compound balance of claim 1 wherein the first end of the extension spring and the first end of the spiral rod subassembly are engaged with the carrier element so that the extension spring and the spiral rod subassembly are substantially parallel to each other.

4. The compound balance of claim 1 further comprising an assembly connector having a spring attachment portion for the non-permanent and secure engagement with the first end of the extension spring.

5. The compound balance of claim 4 wherein the spring attachment portion is threaded to threadably engage the extension spring.

6. The compound balance of claim 1 wherein one side the carrier element contains a hole through which the extension spring may traverse.

7. The compound balance of claim 1 wherein the carrier element is a conventional carrier.

8. The compound balance of claim 6 wherein at least one tab is disposed within the hole to non-permanently secure the assembly connector after a pre-determined amount of turns have been applied to the extension spring.

9. The compound balance of claim 1 wherein the first end of the spiral rod subassembly permits a first end of the spiral rod to extend therefrom.

10. The compound balance of claim 9 further comprising at least one pin that is secured in proximity to the first end of the spiral rod to facilitate turning the spiral rod to apply a pre-determined amount of torque to the torsion spring.

11. The compound balance of claim 10 wherein the direction of the turns to apply torque to the extension spring is opposite the direction turns to apply torque to the torsion spring, permitting the opposing torsional forces to cancel out each other.

12. The compound balance of claim 1 further comprising an upper mounting cap wherein the second end of the extension spring is attached to the upper mounting cap.

13. The compound balance of claim 12 wherein the upper mounting cap is secured to a wall of the jamb channel.

14. The compound balance of claim 1 wherein the second end of the spiral rod subassembly is attached to a wall of the jamb channel.

15. A compound balance cartridge comprising:
a) an extension spring having a first end and a second end;
b) a spiral rod subassembly consisting of a spiral rod encased in a torsion spring, the spiral rod subassembly having a first end and a second end;
c) an upper mounting cap sized to fit and freely travel within the jamb channel; and
d) a carrier element sized to fit and substantially freely travel within a jamb channel of a window assembly; wherein the first end of the extension spring and the first end of the spiral rod subassembly are engaged with the carrier element and the second end of the extension spring and the second end of the spiral rod subassembly are secured to the upper mounting cap such that the extension spring and the spiral rod subassembly are aligned next to and are substantially parallel to each other.

16. The compound balance cartridge of claim 15 further comprising a containment tube surrounding the torsion spring.

17. The compound balance cartridge of claim 15 wherein the first end of the extension spring and the first end of the spiral rod subassembly are engaged with the carrier element such that the extension spring and the spiral rod subassembly are aligned next to and are substantially parallel to each other.

18. The compound balance cartridge of claim 15 further comprising an assembly connector having a spring attachment portion for the non-permanent and secure engagement with the first end of the extension spring.

19. The compound balance cartridge of claim 15 wherein the spring attachment portion is threaded to threadably receive the first end of the extension spring.

20. The compound balance cartridge of claim 15 wherein one side of the carrier element contains a hole through which the first end of the extension spring may traverse.

21. The compound balance cartridge of claim 15 wherein the assembly connector is secured to the first end of the extension spring.

22. The compound balance cartridge of claim 19 wherein at least one tab is disposed within the hole to non-permanently secure the assembly connector after a pre-determined amount of turns have been applied to the extension spring.

23. The compound balance cartridge of claim 15 wherein the first end of the spiral rod is extendable from a first end of the spiral rod subassembly.

24. The compound balance cartridge of claim 23 further comprising at least one pin that is secured in proximity to the first end of the spiral rod to facilitate turning the spiral rod to apply a pre-determined amount of torque to the torsion spring.

25. The compound balance cartridge of claim 24 wherein the direction of the turns to apply a torsional force to the extension spring is opposite the direction of the turns to apply a torsional force to the torsion spring, thereby permitting the opposing torsional forces to cancel out each other.

26. The compound balance cartridge of claim 15 wherein the second end of the extension spring and the second end of the spiral rod subassembly are permanently attached to the upper mounting cap.

27. The compound balance cartridge of claim 26 wherein the upper mounting cap may be secured to a wall of the jamb channel.

28. The compound balance cartridge of claim 27 wherein the upper mounting cap is non-permanently secured to the wall of the jamb channel.

29. A method for equalizing opposing torsional forces on a carrier element of a compound balance, the compound balance consisting of (i) a spiral rod subassembly having a first end and a second end, the spiral rod subassembly containing a spiral rod, the spiral rod having a first end, a second end which may optionally be secured to a wall of a jamb channel or secured to an upper mounting cap, the first end of the spiral rod having at least one pin securely attached thereto, and a torsion spring encapsulating the spiral rod, (ii) an extension spring aligned next to and parallel to the spiral rod subassembly, the extension spring having a first end and a second end, the second end being secured to the upper mounting cap, and (iii) a carrier element, the method comprising the steps of:
(a) applying a torsional force to the torsion spring by rotating the spiral rod a pre-determined number of turns and then permitting the spiral rod to retract into the spiral rod subassembly and non-permanently seat itself within the second end of the spiral rod subassembly;
(c) securing the extension spring to the upper mounting cap;
(d) turning the extension spring a pre-determined number of turns such that the torsional force applied to the extension spring is opposite from the direction of the turns that have been applied to the torsion spring, so that the opposing torsional forces acting on the carrier element substantially balance out each other.

30. The method of claim 29 further comprising a containment tube surrounding the torsion spring.

31. The method of claim 29 wherein the torsional force applied to the extension spring is achieved by turning an assembly connector attached to the first end of the extension spring.

32. The method of claim 29 wherein the assembly connector is seated against a tab within a hole in the carrier element to retain the torsional force applied to the extension spring.

33. The method of claim 29 wherein the at least one pin at the first end of the spiral rod is seated within an interior opening in the carrier element in proximity and adjacent to the hole through which the extension spring extends.

34. The method of claim 29 wherein the upper mounting cap is attached to the wall of the jamb channel.

35. The method of claim 29 wherein both the second end of the extension spring and the second end of the spiral rod subassembly are secured next to each other on the upper mounting cap.
